(19) United States
(12) Patent Application Publication
(10) Pub. No.: US 2002/0056300 A1
(43) Pub. Date: May 16, 2002

(54) Electromechanical lock

(75) Inventors: Doyon Pierre, Ile Bizard (CA); Yves Messier, Dollard-des-Ormeaux (CA); Charles Stephenson, Lexington, KY (US)

Correspondence Address: OGILVY RENAULT, 1981 MCGILL COLLEGE AVENUE, SUITE 1600, MONTREAL, QC, H3A2Y3, CA

(73) Assignee: Ilco Unican Inc.

(21) Appl. No.: 09/985,731

(22) Filed: Nov. 6, 2001

Related U.S. Application Data
(63) Continuation of application No. PCT/CA00/00518, filed on May 5, 2000.

(30) Foreign Application Priority Data
May 6, 1999 (CA) 2,271,348

(51) Int. Cl. E05B 37/08

(52) U.S. Cl. 70/303 A

(57) ABSTRACT

A lock (10) suited for locking safes and vaults comprises an access control system (12) and a locking device (14). The access control system (12) is provided with an anti-tampering system (24, 41 and 70) which is adapted to provide indication of illegal separation of the parts (30 and 60) housing the access control system (12). The locking device (14) includes a bolt assembly (20) which may be configured to provide a spring-loaded bolt or, alternatively, a deadbolt. The locking device (14) further comprises a re-locking mechanism (202 and 202′) adapted to prevent retraction of the bolt (20) upon displacement of the cover (108) of the lock casing (106).

### RELATED APPLICATIONS

This is a continuation of International PCT Application No. PCT/CA00/00518 filed on May 5, 2000, which claims benefit of Canadian Application No. 2,271,348.

### BACKGROUND OF THE INVENTION

1. Field of the Invention

The present invention relates to locks and, more particularly, pertains to locks suited for use with safes and vaults.

2. Description of the Prior Art

It is well known to securely store valuable items in high security enclosures, such as safes and vaults. It is essential to ensure against unauthorized unlocking of such security enclosures which can be subject to various attacks from persons employing conventional safe-cracking techniques or sophisticated equipment for applying electrical or magnetic fields to manipulate elements of the locking mechanism to thereby open it.

Over the years numerous locking mechanisms and access control systems have been developed with various anti-tampering devices employing mechanical and/or electrical elements to ensure against unauthorized operation and to effect cooperative movement among the elements for authorized locking and unlocking operations.

For instance, U.S. Pat. No. 5,592,838 issued on Jan. 14, 1997 to Clark et al. discloses a safe lock having an interposer which is adapted to block the mechanism used for retracting a bolt when the back plate of the lock housing is removed from the housing.

Although the locking mechanism described in the above patent is effective to prevent opening of a locked enclosure, it has been found that there is a need for a new electromechanical lock having high security features.

### SUMMARY OF THE INVENTION

It is therefore an aim of the present invention to provide a new lock that increases security.

It is also an aim of the present invention to provide a compact and reliable lock.

It is also an aim of the present invention to provide a versatile lock suited for used in a number of applications.

It is also an aim of the present invention to provide a lock having a bolt which could be configured as a deadbolt or a spring-loaded bolt.

It is also an aim of the present invention to provide a lock having an electronic access control system with a simple and efficient anti-tampering system.

Therefore, in accordance with the present invention, there is provided a lock comprising driver means adapted to be connected to a source of mechanical energy for opening the lock, latch lever means engageable by said driver means for moving bolt means to open the lock, said latch lever means having a hook member adapted to be engaged in a catch defined in said driver means, interfering means defining a recess, and state selection means for either causing said interfering means and said driver means to move jointly or not, said hook member being biased against said driver means and said interfering means without engagement and operationally engaging said catch when said hook member moves into said recess.

In accordance with a further general aspect of the present invention, there is provided an anti-tampering device for an electronic access control system of the type used for allowing a lock to be unlocked when a valid access code has been entered. The device comprises at least two housing components adapted to be assembled together for housing a control circuit, a pair of conductive components adapted to assume a first relative position to maintain the control circuit in a normal operational mode when said housing components are assembled together and a second relative position to cause said control circuit to fall in a tamper mode when said housing components are disassembled.

In accordance with a further general aspect of the present invention, there is provided a lock comprising a casing, cover means for closing said casing, a bolt slidably disposed within said casing for movement between extended and retracted positions, latch lever means adapted to be connected to a source of mechanical energy for displacing said bolt between said extended and retracted positions thereof, and a re-locking mechanism comprising an interfering member normally maintained in an idle position and which upon alteration of the relative disposition of said cover means and said casing is automatically displaced to a functional position thereof in which said interfering member is engaged with said bolt so as to prevent said bolt from being displaced to said retracted position thereof.

In accordance with a further general aspect of the present invention, there is provided a convertible bolt assembly for a lock, comprising a bolt head displaceable between extended and retracted positions, a bolt tail adapted to be connected to a source of mechanical energy for displacing said bolt head between said extended and retracted positions thereof, and interchangeable connection means for one of spring-loading and fixedly securing said bolt tail relative to said bolt head for selectively configuring said convertible bolt assembly as a spring-loaded bolt and a deadbolt.

In accordance with a further general aspect of the present invention there is provided an electromechanical lock comprising an access control system adapted to be mounted on a first side of a door, a bolt retraction mechanism mounted on a second side of the door for moving a bolt between extended and retracted positions when a valid entry has been validated by said access control system, and a drive shaft extending through the door between said access control system and said bolt retraction mechanism for operatively coupling said lock mechanism to a source of mechanical energy, said drive shaft defining a passage for allowing at least one elongated flexible conductor to extend between said access control system and said bolt retraction mechanism.

### BRIEF DESCRIPTION OF THE DRAWINGS

Having thus generally described the nature of the invention, reference will now be made to the accompanying drawings, showing by way of illustration a preferred embodiment thereof, and in which:

FIG. 1 is an exploded perspective view of an access control system of a lock in accordance with a first embodiment of the present invention;

FIG. 2 is a cross-sectional view of a front enclosure of the access control system of FIG. 1;

FIG. 3 is a cross-sectional view of a back enclosure of the access control system of FIG. 1;

FIG. 4 is an elevational view of a locking device used in combination with the access control system of FIG. 1 and shown in a locked position thereof;

FIG. 5 is an elevational view of the locking device of FIG. 4 shown in an unlocked position thereof.

FIG. 6 is an exploded perspective view of an actuator sub-assembly of the locking device;

FIG. 7 is an exploded perspective view of a bolt sub-assembly of the locking device;

FIG. 8 is an exploded perspective view of a cover adapted to be mounted to the casing of the locking device illustrated in FIGS. 4 and 5;

FIG. 9 is a perspective view of an interfering member of a re-locking mechanism of the locking device;

FIG. 10 is an exploded perspective view of a re-locking mechanism adapted to be installed in the casing of the locking device to prevent the bolt from being retracted if the cover is withdrawn from the casing in accordance with a second embodiment of the present invention.

### DESCRIPTION OF THE PREFERRED EMBODIMENTS

Now referring to the drawings, an electromechanical lock 10 particularly suited for selectively preventing and enabling opening of safes and vaults will be described.

According to a first embodiment of the present invention, the electromechanical lock 10 generally comprises an access control system 12 and a locking device 14 (FIGS. 4 to 9) respectively mounted to outer and inner surfaces of a door (not shown).

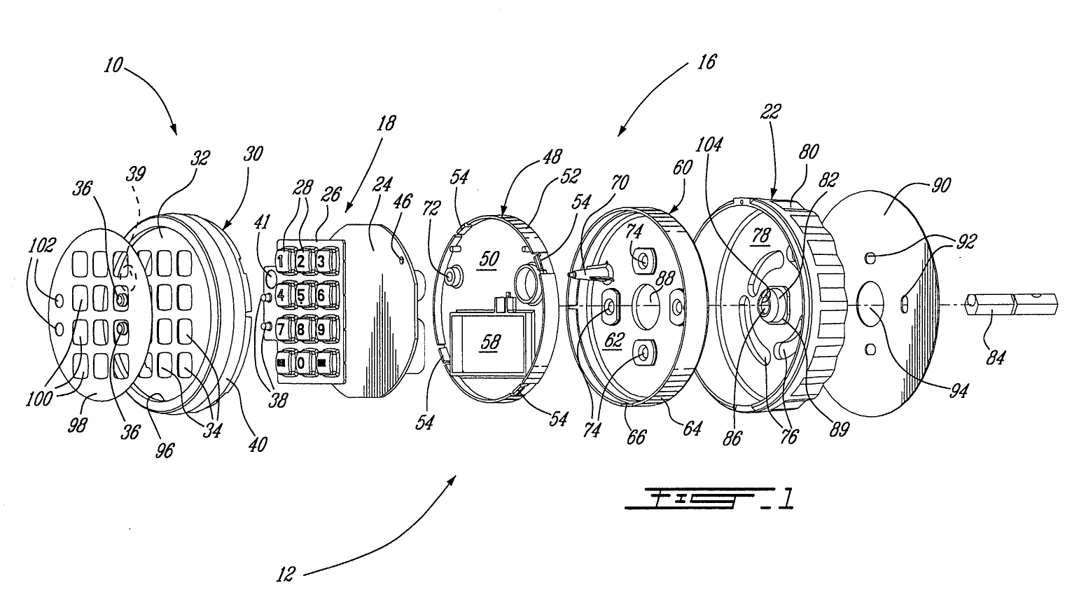

As seen in FIG. 1, the access control system 12 is housed in a housing 16 in which an electronic system 18 is disposed for allowing or preventing a bolt 20 (see FIGS. 4, 5 and 7) to be retracted by manual operation of a turn wheel 22 rotatably mounted about the housing 16.

More specifically, the electronic system 18 includes an electronic circuit board 24 and a keypad 26 provided in the form of a silicon membrane. The keypad 26 includes a number of data entry key buttons 28 for activation to enter combination and initialization data, as is well known in the art. The data entry key buttons 28 are provided with respective carbon contact points (not shown) to activate contacts in the electronic board 24 in response of pressure exerted on the entry key buttons 28. A source of power (not shown), such as batteries, may be disposed within the housing 16 for powering the electronic circuit board 24.

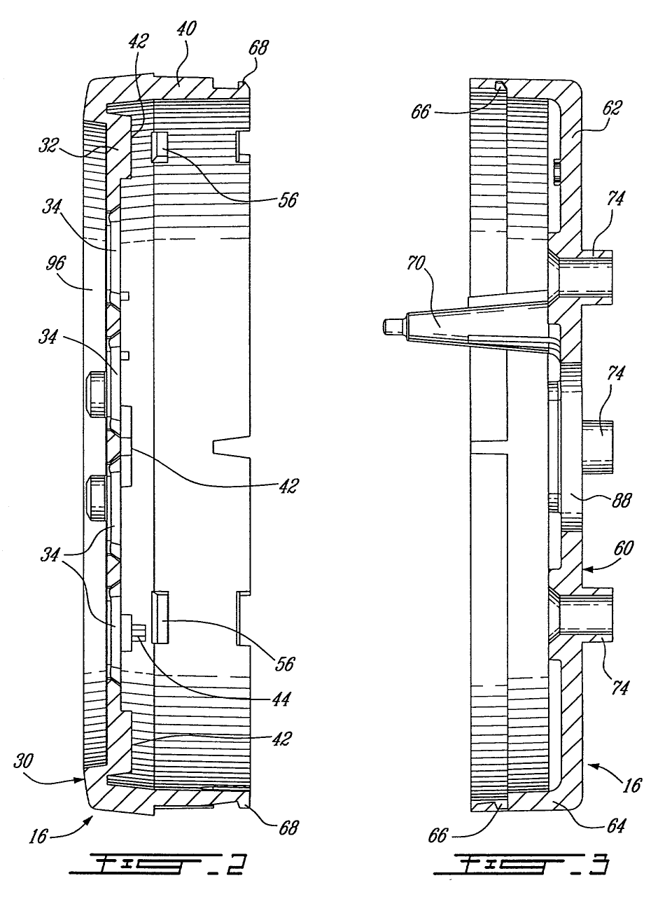

The housing 16 includes a front enclosure 30 having a circular front wall 32 defining an array of openings 34 configured and disposed to receive corresponding data entry key buttons 28 of the keypad 26. The circular front wall 32 further defines two circular openings 36 for receiving corresponding visual indicators 38 and a recess 39 adapted to accommodate a conductive contact 41 integrated in the keypad 26 for purposes to be described hereinafter. A cylindrical wall 40 extends rearwardly from the periphery of the circular front wall 32 so as to define therewith an internal space sized and configured to receive the keypad 26 and the electronic circuit board 24. As seen in FIG. 2, four circumferentially distributed shoulders 42 extend integrally from the inner surface of the circular front wall 32 to receive the electronic circuit board 24. Three pegs 44 also extend at right angles from the inner surface of the circular front wall 32 for engagement within corresponding holes 46 defined in the electronic circuit board 24. The shoulders 42 and the pegs 44 ensure proper positioning of the electronic circuit board 24 within the housing 16.

Once the keypad 26 and the electronic circuit board 24 have been successively installed within the front enclosure 30 as described hereinbefore, an intermediate tamper cover 48 (see FIG. 1) is snapped in interlocking engagement within the top enclosure 30. The intermediate cover 48 comprises a circular wall 50 and a cylindrical wall 52 extending on both sides of the circular wall 50. The cylindrical wall 52 is provided at a front end thereof with four integral circumferentially distributed flexible hooks 54 adapted to be pushed into engagement within corresponding grooves 56 (FIG. 2) defined in the inner surface of the cylindrical wall 40 of the front enclosure 30. A rectangular cavity 58 is defined in the circular wall 50 for receiving a pair of AAA batteries for powering the electronic circuit board 24, as mentioned hereinbefore.

As seen in FIG. 1, the housing 16 further comprises a rear enclosure 60 having a circular bottom wall 62 from the periphery of which a cylindrical side wall 64 extends. A pair of diametrically opposed internal grooves 66 are defined at the front end of the cylindrical side wall 64 for interlocking engagement with corresponding flexible hooks 68 integrally formed at the rear end of the cylindrical wall 40 of the front enclosure 30. This arrangement advantageously allows the batteries (not shown) to be readily replaced, when required, by simply urging the flexible hooks 68 of the front enclosure 30 out of the grooves 66 of the rear enclosure 60.

Thereafter, the front and rear enclosures 30 and 60 can be readily reassembled together by manually pushing the flexible hooks 68 back into the grooves 66.

As seen in FIG. 1, a spacer or protrusion 70 extends frontwardly from the circular bottom wall 62 of the rear enclosure 60 through a hole 72 defined in the intermediate cover 48 and a hole (not shown) defined in the electronic circuit board 24 in order to push the conductive contact 41 away from the electronic circuit board 24 into the recess 39 so that there is no electrical continuity between the conductive contact 41 and the electronic circuit board 24 when the rear closure 60 is assembled to the front closure 30. However, in the event that the front closure 30 is removed from the rear closure 60, the protrusion 70 will no longer push on the conductive contact 41 to maintain the same away from the electronic circuit board 24 and, thus, the conductive contact 41 will engage the electronic circuit board 24 at a point of contact thereof, thereby resulting in an electrical short across circuit traces on the circuit board 24. This will cause the electronic system 18 to fall into a tamper mode which allows the retraction of the bolt 20 when a valid entry is detected but which provides a visual signal via one of the visual indicators 38 that an illegal manipulation has been performed. It is understood, that the circuit of the electronic circuit board 24 can be configured to enable authorized person to enter a code which allows them to disassemble the housing 18 without causing the electronic system 18 to fall into the tamper mode. The above described arrangement constitutes an efficient and simple anti-tampering system which could be used in a variety of applications where it is desired to indicates unauthorized separation of parts of an enclosure housing a given electronic access control system.

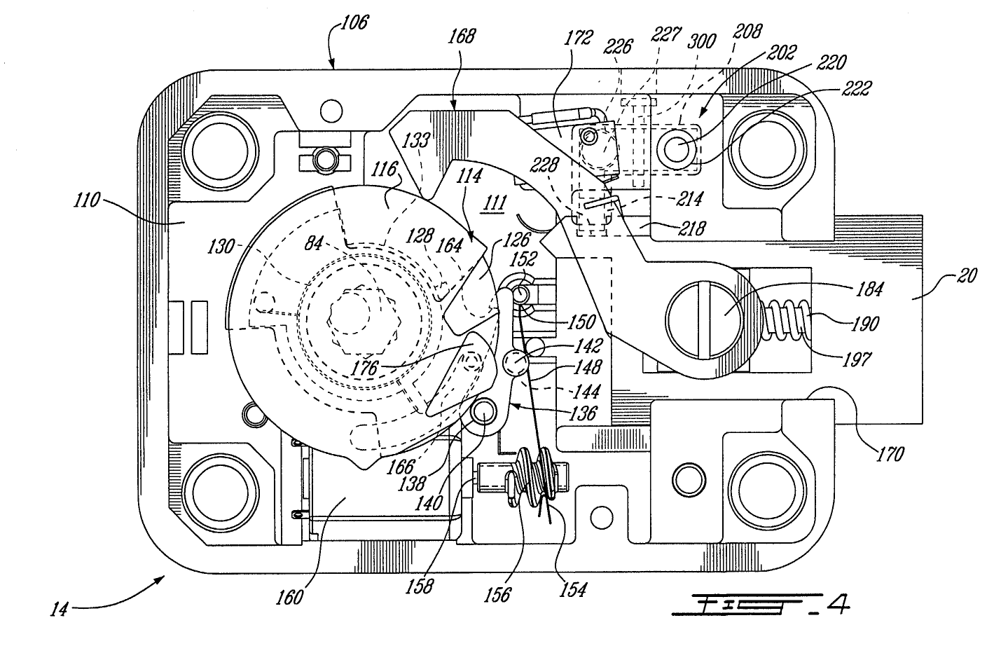

As seen in FIG. 3, four circumferentially distributed hollow projections 74 extend rearwardly from the bottom wall 62 of the rear closure 60 for engagement with corresponding circumferentially spaced-apart curved slots 76 defined in the bottom wall 78 of the turn wheel 22. As seen in FIG. 1, an externally corrugated cylindrical side wall 80 extends from the periphery of the bottom wall 78 and defines therewith a recess having a diameter slightly greater than the external diameter of the front and rear enclosures 30 and 60, thereby enabling the turn wheel 22 to be fitted thereon for rotational movement with respect thereto. According to one embodiment of the present invention, the engagement of the hollow projection 74 within the slots 76 limits the rotational movement of the turn wheel 22 relative to the housing 16 to 68 degrees.

The hollow projections 74 also allow fasteners (not shown) to extend through the rear closure 60 in order to secure the same to the outer surface of a door (not shown) without interfering with the rotational movement of the turn wheel 22 disposed therebetween. Accordingly, the housing 16 will remain in a fixed position relative to the door (not shown), while the turn wheel 22 will be allowed to rotate with respect thereto in order to displace the bolt 20, as will be explained hereinafter.

A central hollow projection 82 extends frontwardly from the bottom wall 78 of the turn wheel 22 for receiving a portion of an hexagonal hollow drive shaft 84 (see FIG. 1), which extends through the door (not shown) and into the locking device 14 for enabling the retraction of the bolt 20 after a valid entry has been detected by the electronic circuit board 24. The hollow projection 82 defines an internal shoulder 86 against which the leading end of the hollow drive shaft 84 may abut to limit axial movement thereof.

As seen in FIG. 1, a central hole 88 is defined in the bottom wall 62 of the rear closure 60 for receiving the central hollow projection 82, thereby allowing wires (not shown) to pass from the electronic circuit board 24 and the source of power (not shown) through the intermediate cover 48 via holes 88 defined therein, through the hollow drive shaft 84 and to the locking device 14. As seen in FIG. 1, the hollow drive shaft 84 is open along one longitudinal side thereof to allow wires to pass from the drive shaft 84 to the locking device 14. A square base 89 having rounded corners is provided at the bottom of the central hollow projection 82 for engagement within the central hole 88. This contributes to ensure proper positioning of the rear enclosure 60 in the turn wheel 22.

A back plate 90 defining four holes 92 adapted to be placed in register with the hollow projections 74 of the rear closure 60 may be disposed between the outer surface of the door (not shown) and the turn wheel 22. The back plate 90 further defines a central hole 94 for allowing the hollow drive shaft 84 to extend therethrough.

A recess 96 may be defined in the front enclosure 30 to accommodate a face plate 98 defining an array of openings 100 corresponding to the array of openings 34 defined in the front wall 32 of the front enclosure 30. The face plate 98 further defines a pair of holes 102 configured and sized to be disposed about the openings 36 defined in the front wall 32 of the front enclosure 30. The face plate 98 may be fixed to the front wall 32 by means of an adhesive or by any other suitable means, such as snapped fasteners.

According to a preferred embodiment of the present invention, the front enclosure 30, the intermediate cover 48, the rear enclosure 60 and the turn wheel 22 are all molded from a plastic material. In this case, a metal insert 104 may be installed within the central hollow projection 82 to prevent premature wear of the turn wheel 22 due to the friction between the hollow drive shaft 84 and the internal surface of the central hollow projection 82.

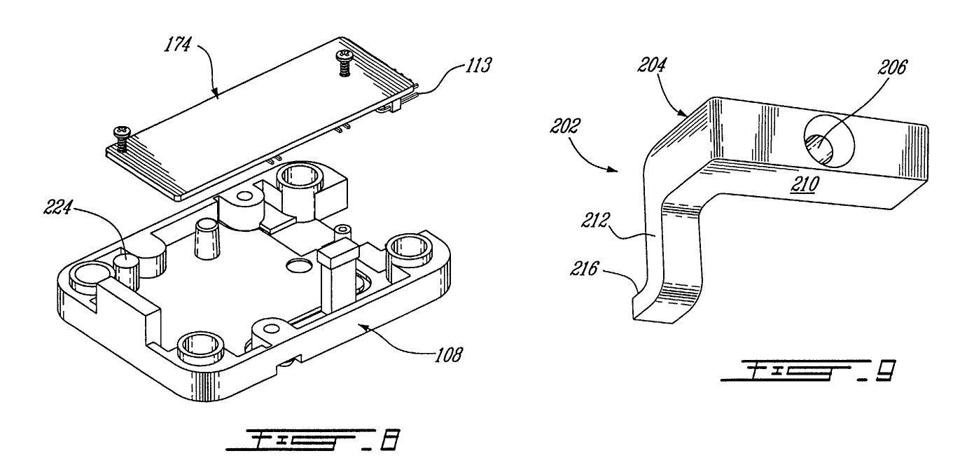

The locking device 14 includes an electromechanical assembly (FIGS. 4 to 7) housed within a zinc alloy casing 106 with a zinc alloy cover 108 (FIG. 8).

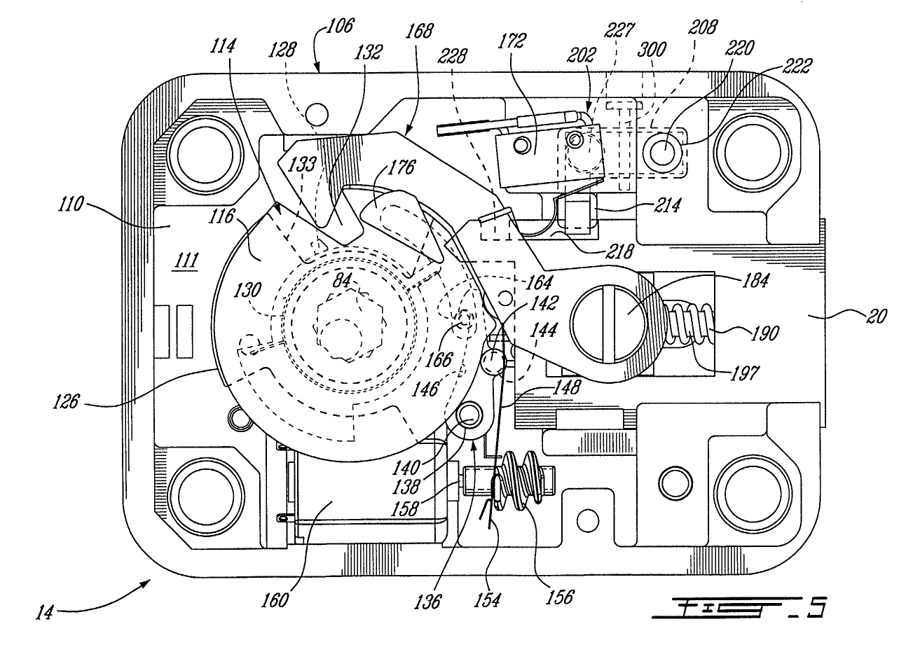

As seen in FIGS. 4 and 5, the casing 106 comprises a base plate 110 having an outer surface adapted to be mounted to the inner side of the door to which the access control system 12 is mounted. A recess 109 (see FIG. 10) is defined in the outer surface of the base plate 110 for defining a passage with the inner side of the door (not shown) for flexible conductors, such as wires, to pass from the open longitudinal side of the drive shaft 84 to a connector 113 attached to the cover 108 (FIG. 8). The inner surface of the base plate 110 provides a mounting surface 111 for the various components of the electro-mechanical assembly illustrated in FIGS. 4 to 7.

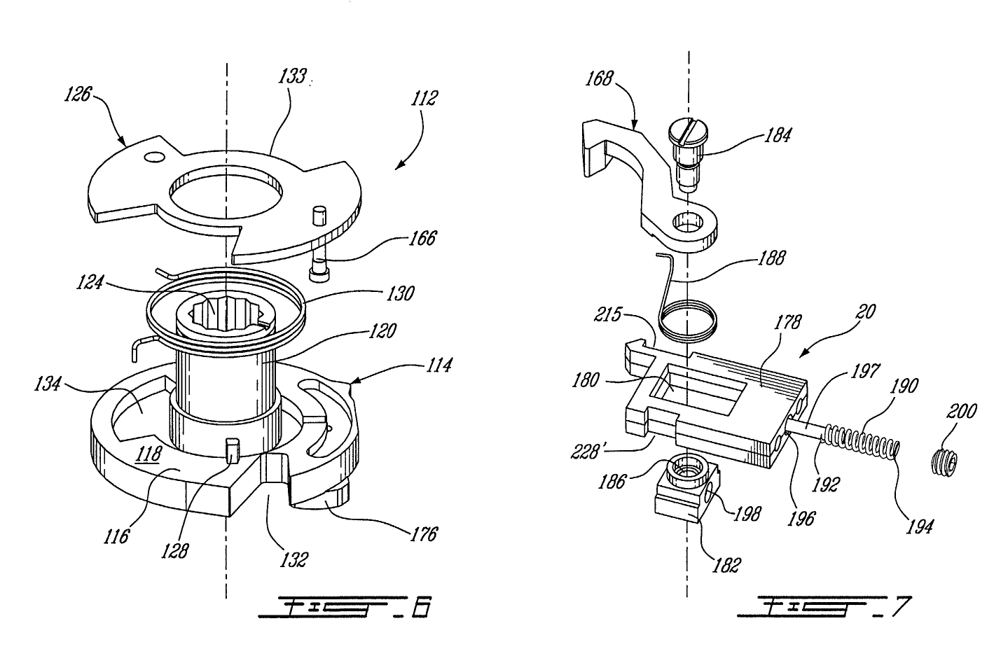

FIG. 6 illustrates an actuator or driver sub-assembly 112 which is adapted to displace the bolt 20 from an extended position to a retracted position when a valid entry has been registered by the electronic system 18. The actuator sub-assembly 112 comprises a driver hub 114 provided with a thick circular disc 116 having an undersurface 118 from which a cylindrical projection 120 protrudes at right angles. The driver hub 114 is installed in the casing 106 with the cylindrical projection 120 thereof extending through passage 122 (see FIG. 10) defined in a raised cylindrical structure extending from the mounting surface 111 of the casing 106. An axially extending hexagonal hole 124 is defined through the cylindrical projection 120 for receiving one end portion of the drive shaft 84 (FIG. 4) so as to operatively connect the turn wheel 22 (FIG. 1) to the driver hub 114. Accordingly, the driver hub 114 is driven by the turn wheel 22 via the drive shaft 84 which extends through the door (not shown) to which the housing 16 and the casing 106 are mounted.

As seen in FIGS. 4 to 6, a disc 126 is spring biased against a stop pin 128 (FIGS. 4, 5 and 6) extending from the undersurface 118 of the driver hub 114 by means of a torsion spring 130 in order to normally prevent access to a catch provided in the form of a cutout portion 132 defined in the circumference of the circular disc 116. The torsion spring 130 is installed about the cylindrical projection 120 in a groove 134 defined in the undersurface 118 of the circular disc 116 of the driver hub 114.

A retaining member 136 provided in the form of a hook defines a hole 138 configured to be fitted on a pivot pin 140 extending at right angles from the mounting surface 111 of the casing 106. A retaining ring (not shown) is installed at the free end of the pivot pin 140 after the retaining member 136 has been installed thereon to prevent dislodgment thereof, while at the same time allowing the retaining member 136 to pivot about the pivot pin 140. As seen in FIGS. 4 and 5, an abutment pin 142 is pressure fitted in a hole 144 defined in the retaining member 136. A spring (not shown) installed on the pivot pin 140 is engaged at one end thereof in a groove 146 defined in the retaining member 136 to normally urge the same in an idle position, wherein the portion of the abutment pin 142 extending below the retaining member 136 is biased against a spring blade 148 having a first connecting end 150 fitted over a pin 152 extending at right angles from the mounting surface 111 of the casing 106 and a second connecting end 154 engaged with a worm gear 156 pressure fitted on an output shaft 158 of a DC motor 160 positioned on the mounting surface 111 of the casing 106. The spring blade 148 advantageously acts as a device to cumulate mechanical energy from the motor 160 when the retaining member 136 cannot move due to rotation of the turn wheel 22.

When a valid entry is registered by the electronic system 18, the motor 160 is powered so as to rotate the worm gear 156 in a direction causing the second connecting end 154 of the spring blade 148 to be displaced towards the motor 160. During this displacement, the spring blade 148 pushes on the abutment pin 142 so as to pivot the retaining member 136 to a functional position thereof, wherein a distal end portion 164 thereof is disposed to engage a pin 166 (FIG. 6) depending downwardly from the disc 126. Accordingly, when the turn wheel 22 will be operated with a view to open the lock 10, the driver hub 114 and the disc 126 will rotate conjointly from a rest position up to a point where the distal end portion 164 of the retaining member 136 will engage the pin 166 depending from the disc 126, thereby preventing the disc 126 from further rotating with the driver hub 114. Continuous rotation of the turn wheel 22 will cause the driver hub 114 to rotate, thereby clearing the cutout portion 132 thereof by positioning the same in a recess 133 defined in the disc 126. A latch lever or spring-loaded arm 168 pivotally connected to the bolt 20 slidably mounted in the casing at 170 will then fall into the cutout portion 132 so that further rotation of the turn wheel 22 will cause the retraction of the bolt 20. Then, the door (not shown) can be opened.

In the event that an invalid entry is registered, the motor 160 will not be powered and, thus, the retaining member 136 will remain biased in its idle position and will consequently not engage the pin 166 during the rotational movement of the disc 126 with the driver hub 114. Therefore, rotation of the turn wheel 22 will cause the driver hub 114 and the disc 126 to rotate conjointly with the disc 126 blocking access to the cutout portion 132. Accordingly, the spring-loaded arm 168 will not be allowed to move into the cutout portion 132 and, thus, the bolt 20 will remain in its extended position.

A switch 172 is installed in the casing 106 for detecting the displacement of the bolt 20. The switch 172 is connected to an electronic PCB 174 (FIG. 8) mounted on an undersurface of the cover 108 for controlling the lock functions. The switch 172 will detect the retraction of the bolt 20 and send a signal to the electronic PCB 174 which will in turn control the operation of the motor 160 in order to displace the second connecting end 154 of the spring blade 148 away from the motor 160 so as to allow the retaining member 136 to return to its idle position. A second switch (not shown) may be mounted on the electronic PCB 174 to provide a signal that the driver hub 114 and thus the turn wheel 22 are back to the rest position after re-locking. The second switch (not shown) ensures that the lock 10 is locked and that the retaining member 136 and the actuator sub-assembly 112 have been fully reset mechanically. A protrusion 176 (FIGS. 4 and 5) extends from the top surface of the circular disc 116 of the driver hub 114 to trigger the second switch (not shown). The collected data are also used to provide visual and audible feedback to the user.

It is understood that the above described locking device 14 could be used as a door mortise lock and is thus not limited to the above described application.

According to a preferred embodiment of the present invention, the bolt 20 can advantageously be spring loaded or, alternatively dead bolted according to the intended application. As seen in FIG. 7, the bolt 20 has a bolt head provided in the form of a generally rectangular body 178 defining a rectangular opening 180 in which a support member or core 182 is disposed. The spring-loaded arm 168, which acts as a bolt tail, is pivotally attached to the core 182 via a shoulder screw 184 engaged in a vertical hole 186 defined in the core 182. A torsion spring 188 is disposed about the vertical hole 186 and has a first end engaged with the core 182 and a second end engaged with the arm 168 to normally urge the same inwardly towards the driver hub 114.

For spring loaded applications, a compression spring 190 having leading and trailing ends 192 and 194 is inserted in an axially extending threaded bore 196 defined in the front end portion of the body 178. The leading end 192 is received in a circular recess 198 defined in the core 182 and a dowel fastener 200 is threadably engaged in the threaded bore 196 against the trailing end 194 of the compression spring 190 in order to maintain the same in compression between the core 182 and the body 178 of the bolt 20.

The above described spring-loaded bolt can be readily converted to a dead bolt by driving the dowel fastener 200 out of the threaded bore 196 to permit the insertion of a solid pin 197 within the threaded bore 196. The solid pin is sized so as to extend through the cavity defined by the compression spring 190 and into the recess 198. The dowel fastener 200 is then screwed back into the threaded bore 196 to retain the compression spring 190 and the solid pin (not shown) in position. In this case, the core 182 is rigidly connected to the body 178 of the bolt 20, since the solid pin extends between the core 182 and the dowel fastener 200 which is fixed relative to the body 178.

Referring now to FIGS. 4 and 5, a re-locking mechanism 202 adapted to prevent the lock 10 from opening under various types of attack, such as impacts on the lock itself or on the structure to which the lock 10 is mounted, will be described. More particularly, the re-locking mechanism 202 is adapted to prevent retraction of the bolt 20 in the event that the position of the cover 108 is altered relative to the casing 106.

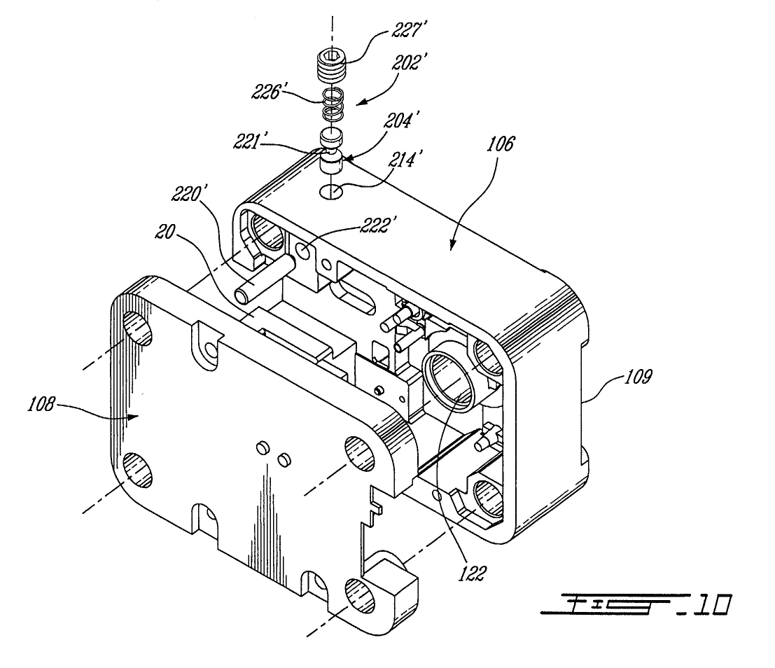

The re-locking mechanism 202 comprises an interfering member 204 (see FIG. 9) in which a transversal bore 206 is defined for receiving a pivot pin in order to pivotally mount the interfering member 204 in a L-shaped recess 208 defined in the outer surface of the base plate 110 of the casing 106. The interfering member 204 includes an L-shaped portion 210 from which depends a curved end portion 212. The curved end portion 212 is configured, once the interfering member 204 has been installed in the L-shaped recess 208, to extend through a bore 214 defined in the bottom surface of the L-shaped recess 208.

In order to maintain the interfering member 204 in an ineffective position, where the tip of the curved end portion 212 thereof is located in a recess 215 (see FIG. 7) defined in the body 178 of the bolt 20 with surfaces 216 and 218 in sliding contact, a pin 220 extending through a bore 222 defined in the base plate 110 is pushed against the free end of the L-shaped portion 210 of the interfering member 204 by a raised structure 224 (FIG. 8) extending from the inner surface of the cover 108. The length of the pin 220 is greater than that of the bore 222 in order to allow the raised structure 224 to push the pin 220 partially outwardly of the casing 106 when the cover 108 is assembled to the casing 106. Under normal lock operations, the interfering member 204 is pushed by the pin 220 against a compression spring 226 disposed in a small recess 227 defined in the bottom wall of the L-shaped recess 208. In this position, the interfering member 204 does not block the sliding movement of the bolt 20 and the same may thus be displaced as per the way described hereinbefore.

However, in the event that the cover 108 is removed from the casing 106, the raised structure 224 will no longer be in contact with the pin 220 and consequently the same will no longer exert a force on the interfering member 204 and, thus, the compression spring 226 will cause the interfering member 204 to pivot against a pin or a screw 300 retaining the interfering member 204 to the casing 106, thereby retracting the curved end portion 212 of the interfering member 204 in an indentation 228 defined in the recess 215 of the body 178 of the bolt 20 so as to interfere with the retraction thereof. This thus prevents the opening of the lock 10.

It is noted that the cover 108 is attached to the casing 106 to be readily disassembled therefrom due to impacts on the casing 106 or the structure in which the lock 10 is used.

FIG. 10 illustrates a re-locking mechanism 202′ used in combination with the casing 106 and the cover 108 in accordance with a second embodiment of the present invention. The re-locking mechanism 202′ comprises an interfering member 204′ which is urged towards the bolt 20 by a spring 226′. The interfering member 204′ and the spring 226′ are received in a transversal bore 214′ defined in the casing 106 in a direction perpendicular to the movement of the bolt 20′. A threaded fastener 227′ is threadably engaged in the bore 214 for preventing withdrawal of the spring 226′ and the interfering member 204′ from the bore 214′. A second bore 222′ is defined in the casing 106 so as to intersect the bore 214 for allowing a lock pin 220′ to engage a catch 221′ formed on the interfering member 204′. The lock pin 220′ is freely mounted in the second bore 222′ and pushed therein by the under surface of the cover 108. When the cover 108 is assembled to the casing 106, the lock pin 220′ is pushed in interlocking engagement in the catch 221′ of the interfering member 204′ so as to maintain the spring 226′ in a compressed state and prevent the bolt 20′ from being engaged by the interfering member 204′. However, in the event that the cover 108 is removed from the casing 106, the lock pin 220′ will no longer be pushed into the second bore 222′, thereby allowing the spring-loaded interfering member 204′ to become interlockingly engaged in a recess 228 (see FIG. 7) defined in a side of the bolt 20 so as to prevent retraction thereof.

1. A lock comprising driver means adapted to be connected to a source of mechanical energy for opening the lock, latch lever means engageable by said driver means for moving bolt means to open the lock, said latch lever means having a hook member adapted to be engaged in a catch defined in said driver means, interfering means defining a recess, and state selection means for either causing said interfering means and said driver means to move jointly or not, said hook member being biased against said driver means and said interfering means without engagement and operationally engaging said catch when said hook member moves into said recess.

2. A lock as defined in claim 1, wherein said driver means include a driver hub having a circumferential surface, and wherein said interfering means has a circumferential surface, said hook member being biased against said circumferential surfaces of said driver hub and said interfering member.

3. A lock as defined in claim 1, wherein said state selection means is operational for selectively retaining said interfering means in an idle position in which said hook member is free to engage said catch, thereby allowing displacement of said bolt means by said driver means.

4. A lock as defined in claim 3, wherein said interfering means include an interfering member mounted for moving jointly with said driver means in absence of retaining engagement by said state selection means.

5. A lock as defined in claim 4, wherein said state selection means include a retaining member displaceable from an idle position to a functional position in which said retaining member is disposed to intercept said interfering member so as to prevent said interfering member from further moving with said driver means.

6. A lock as defined in claim 5, wherein said state selection means further include a resilient member connected to a driven worm gear for displacing said retaining member between said idle and functional positions thereof.

7. A lock as defined in claim 6, wherein said resilient member includes a spring blade having a fixed end portion and an opposed end portion engaged at one end thereof with said driven worm gear.

8. A lock as defined in claim 5, wherein said retaining member is normally urged in said idle position thereof by a biasing member.

9. A lock as defined in claim 5, wherein said driver means includes a driver hub in which said catch is defined, said catch being normally blocked by said interfering member, and wherein said hook member is adapted to fall into said catch when said interfering member is retained captive by said retaining member, thereby allowing said driver hub to displace said bolt means.

10. A lock as defined in claim 9, wherein said catch includes a cutout portion defined in a peripheral surface of said hub.

11. A lock as defined in claim 10, wherein said interfering member includes a disc mounted to said driver hub, said driver hub being provided with a stopper against which said disc is biased to prevent said hook member from becoming engaged into said cutout portion.

12. A lock as defined in claim 3, wherein said bolt means include a bolt head, a latch lever support to which said hook member is pivotally mounted for engaging said driver means, and interchangeable connection means for one of spring-loading and rigidly securing said latch lever support relative to said bolt head for selectively configuring said bolt means as a spring-loaded bolt and a deadbolt.

13. A lock as defined in claim 12, wherein said bolt head defines an elongated slot extending in a direction of travel of said bolt head, said latch lever support being adapted to be received within said elongated slot and retained therein by a selected one of a lock pin and a spring member.

14. A lock as defined in claim 13, wherein said lock pin and said spring member are adapted to be loaded in position through a threaded bore defined in said bolt head and leading to said elongated slot, said threaded bore being adapted to receive a threaded fastener for preventing axial removal of said selected one of said lock pin and said spring member.

15. A lock as defined in claim 3, wherein said lock further includes a casing having a mounting surface adapted to be mounted on an inner surface of a door, and wherein said driver means include a drive shaft extending through the door and into said casing, said drive shaft defining a passage for allowing at least one elongated flexible conductor to extend from said casing through said drive shaft to a side of the door opposite the inner side thereof.

16. A lock as defined in claim 15, wherein said mounting surface of said casing defines a recess for receiving said at least one elongated flexible conductor from said passage of said drive shaft.

17. A lock as defined in claim 15, wherein said drive shaft is open along at least one part of a longitudinal side thereof.

18. A lock as defined in claim 3, further including a casing, cover means for closing said casing, and a re-locking mechanism comprising an interfering member normally maintained in an idle position and which upon alteration of the relative disposition of said cover means and said casing is automatically displaced to a functional position thereof in which said interfering member is engaged with said bolt means so as to prevent retraction of said bolt means.

19. A lock as defined in claim 18, wherein said interfering member is spring-loaded, and wherein said re-locking mechanism further includes a locking member displaceable between engaged and disengaged positions, said locking member being maintained in said engaged position to retain said interfering member in said idle position thereof when said cover means is assembled to said casing and displaced to said disengaged position thereof to allow movement of said interfering member to said functional position thereof when said relative position of said cover means and said casing is altered.

20. A lock as defined in claim 19, wherein said locking member includes a pin freely mounted within a bore defined in said casing, said pin being pushed into locking engagement with said interfering member by said cover means when the same is assembled to said casing.

21. A lock as defined in claim 19, wherein a recess is defined in said bolt for receiving said interfering member.

22. A lock as defined in claim 21, wherein said interfering member is displaceable in a direction transversal to a moving direction of said bolt.

23. An anti-tampering device for an electronic access control system of the type used for allowing a lock to be unlocked when a valid access code has been entered, comprising at least two housing components adapted to be assembled together for housing a control circuit, a pair of conductive components adapted to assume a first relative position to maintain the control circuit in a normal operational mode when said housing components are assembled together and a second relative position to cause said control circuit to fall in a tamper mode when said housing components are displaced with respect to each other.

24. An anti-tampering device as defined in claim 23, further comprising a spacer adapted to maintain said conductive components out of contact when said housing components are assembled, while allowing said conductive components to come in contact when said housing components are disassembled.

25. An anti-tampering device as defined in claim 24, wherein said spacer extends from one of said housing components so as to push one of said conductive components away from another one of said conductive components when said housing components are assembled.

26. An anti-tampering device as defined in claim 25, further including an intermediate tampering cover adapted to be rigidly received within said other one of said housing components to sandwich the control circuit therebetween, said intermediate tampering cover defining a hole for allowing said spacer to extend therethrough.

27. An anti-tampering device as defined in claim 26, wherein said spacer is provided in the form of a protrusion extending integrally from said one housing component.

28. A lock comprising a casing, cover means for closing said casing, a bolt slidably disposed within said casing for movement between extended and retracted positions, latch lever means adapted to be connected to a source of mechanical energy for displacing said bolt between said extended and retracted positions thereof, and a re-locking mechanism comprising an interfering member normally maintained in an idle position and which upon alteration of the relative positioning of said cover means and said casing is automatically displaced to a functional position thereof in which said interfering member is engaged with said bolt so as to prevent said bolt from being displaced to said retracted position thereof.

29. A lock as defined in claim 28, wherein said interfering member is spring-loaded, and wherein said re-locking mechanism further includes a locking member displaceable between engaged and disengaged positions, said locking member being maintained in said engaged position to retain said interfering member in said idle position thereof when said cover means is assembled to said casing and displaced to said disengaged position thereof to allow movement of said interfering member to said functional position thereof when said relative position of said cover means and said casing is altered.

30. A lock as defined in claim 29, wherein said locking member includes a pin freely mounted within a bore defined in said casing, said pin being pushed into locking engagement with said interfering member by said cover means when the same is assembled to said casing.

31. A lock as defined in claim 30, wherein a recess is defined in said bolt for receiving said interfering member.

32. A lock as defined in claim 31, wherein said interfering member is displaceable in a direction transversal to a moving direction of said bolt.

33. A convertible bolt assembly for a lock, comprising a bolt head displaceable between extended and retracted positions, a bolt tail adapted to be connected to a source of mechanical energy for displacing said bolt head between said extended and retracted positions thereof, and interchangeable connection means for one of spring-loading and fixedly securing said bolt tail relative to said bolt head for selectively configuring said convertible bolt assembly as a spring-loaded bolt and a deadbolt.

34. A convertible bolt assembly as defined in claim 33, wherein said bolt head defines an elongated slot extending in a direction of travel of said bolt head, and wherein said interchangeable connection means include a tail support member adapted to be received within said elongated slot and retained therein by a selected one of a lock pin and a spring member.

35. A convertible bolt assembly as defined in claim 34, wherein said lock pin and said spring member are adapted to be loaded in position through a threaded bore defined in said bolt head and leading to said elongated slot, said threaded bore being adapted to receive a threaded fastener for preventing axial removal of said selected one of said lock pin and said spring member.

36. A convertible bolt assembly as defined in claim 35, wherein said bolt tail is pivotally mounted to said tail support member.

37. An electromechanical lock comprising an access control system adapted to be mounted on a first side of a door, a bolt retraction mechanism mounted on a second side of the door for moving a bolt between extended and retracted positions when a valid entry has been validated by said access control system, and a drive shaft extending through the door between said access control system and said bolt retraction mechanism for operatively coupling said lock mechanism to a source of mechanical energy, said drive shaft defining a passage for allowing at least one elongated flexible conductor to extend between said access control system and said bolt retraction mechanism.

38. An electromechanical lock as defined in claim 37, wherein said bolt retraction mechanism is housed in a casing having a mounting surface adapted to be mounted to the second side of the door, said mounting surface defining a recess for receiving said at least one elongated flexible conductor from said passage of said drive shaft.

39. An electromechanical lock as defined in claim 38, wherein said drive shaft is open along at least one part of a longitudinal side thereof.
